(19) United States
(12) Patent Application Publication
(10) Pub. No.: US 2012/0240562 A1
(43) Pub. Date: Sep. 27, 2012

(54) Exhaust Treatment Device for an Internal Combustion Engine

(75) Inventor: Richard Lorenze Johnson, Dryden, MI (US)

(73) Assignee: GM GLOBAL TECHNOLOGY OPERATIONS LLC, Detroit, MI (US)

(21) Appl. No.: 13/071,040

(22) Filed: Mar. 24, 2011

(51) Int. Cl. F01N 3/10; B23P 11/00; F01N 1/22

(52) U.S. Cl. 60/299; 60/324; 137/15.01

(57) ABSTRACT

An internal combustion engine has an exhaust gas treatment system comprises a multiple piece canister having a first canister portion and a second canister portion, a conical portion extending axially from an end of the first canister portion including a wall that is inclined inwardly, towards a central axis of the multiple piece canister, a funnel portion extending axially from an end of the second canister portion including a wall that is inclined outwardly, away from the central axis of the multiple piece canister, the wall of the conical portion and the wall of the funnel portion defining an insulation gap therebetween and an annular band of insulating and cushioning mat material disposed under compression by the walls within the insulation gap.

### FIELD OF THE INVENTION

Exemplary embodiments of the present invention relate to exhaust treatment devices for internal combustion engines and, more particularly, to an exhaust treatment device having a thermally efficient configuration.

### BACKGROUND

A typical exhaust system for an internal combustion engine may involve the placement of an exhaust treatment system or assembly in close fluid communication with the exhaust manifold of the internal combustion engine. Such an exhaust treatment system is typically a catalytic device in which regulated exhaust constituents (ex. CO, HC, NO_{R}, Particulates, etc.) are converted to non-regulated compounds (ex. CO₂, H₂O, etc.). An exhaust treatment system that is closely coupled to the engine exhaust manifold minimizes thermal loss in the exhaust gas, between the engine and the exhaust treatment system, resulting in higher temperatures and quicker catalytic activation since the catalyst compounds that are typically used for treating engine exhaust gas constituents often operate at optimal efficiency at temperatures in excess of 350° C.

In an exemplary embodiment of an exhaust treatment system, a plurality of catalytic devices may be disposed in a multiple piece housing or canister that is closed at each end by an inlet or an outlet cone. The inlet and outlet cones are in fluid communication with the exhaust system of the internal combustion engine. Each catalytic device is typically constructed as a catalyst coated, flow-though substrate constructed of ceramic or metal, that is supported within the canister by an insulating and cushioning mat material interposed between the outer surface of the flow-through substrate and the inner wall of the canister. An axially extending gap may be located between each catalytic device and can be useful as a location for various sensors that monitor the performance of the exhaust treatment system. The axially extending gap will typically not receive the insulative benefit of the insulating and cushioning mat material that is interposed between the outer surface of the flow-through substrate and the inner wall of the canister and, as such, a portion of the housing or canister may be directly subjected to the high temperatures of the exhaust gas resulting in a portion of the outer surface of the housing or canister reaching temperatures that necessitate the addition of a heat shield. Multiple piece housings have been proposed that have an insulating mat disposed in the region of the axially extending gap. Such solutions may utilize a tapered portion of one of the housing pieces to define a gap into which the insulating mat is disposed. Such designs have suffered during the assembly process which requires that the mat maintain dimensional stability as the multiple housing pieces are engaged with one another through a sliding, axial overlap. Such a sliding assembly method may result in the mat being dimensionally compromised.

### SUMMARY OF THE INVENTION

In an exemplary embodiment of the invention an exhaust gas treatment system for the reduction of regulated exhaust gas constituents produced by an internal combustion engine comprises a multiple piece canister comprising a first canister portion and a second canister portion, a conical portion extending axially from an end of the first canister portion including a wall that is inclined inwardly, towards a central axis of the multiple piece canister, a funnel portion extending axially from an end of the second canister portion including a wall that is inclined outwardly, away from the central axis of the multiple piece canister, the wall of the conical portion and the wall of the funnel portion defining an insulation gap therebetween and an annular band of insulating and cushioning mat material, disposed under compression by the walls, within the insulation gap.

In another exemplary embodiment of the invention, a method is provided for assembling an exhaust gas treatment system for the reduction of regulated exhaust gas constituents produced by an internal combustion engine comprising a multiple piece canister having a first canister portion and a second canister portion, a conical portion extending axially from an end of the first canister portion including a wall that is inclined inwardly, towards a central axis of the multiple piece canister, a funnel portion extending axially from an end of the second canister portion including a wall that is inclined outwardly, away from the central axis of the multiple piece canister, the wall of the conical portion and the wall of the funnel portion defining an insulation gap therebetween and an annular band of insulating and cushioning mat material disposed under compression by the walls within the insulation gap. The method comprises disposing the annular band of insulating and cushioning mat material about the wall of the conical portion and moving the first and second canister portions axially together along the central axis until an end of the wall of the funnel portion is positioned circumferentially about, and adjacent to, an outer surface of the first canister portion to define an insulation gap between the wall of the conical portion and the wall of the funnel portion, wherein the annular band of insulating and cushioning mat material is in compression between the walls to thereby fix the material in place within the insulation gap.

In yet another exemplary embodiment of the invention, an internal combustion engine having an exhaust gas treatment system for the reduction of regulated exhaust gas constituents produced thereby comprises an exhaust manifold configured to conduct exhaust gas from the engine. A split volume, common can catalytic converter is configured to receive the exhaust gas and comprises a multiple piece canister comprising a first canister portion and a second canister portion, a conical portion extending axially from an end of the first canister portion including a wall that is inclined inwardly, towards a central axis of the multiple piece canister, a funnel portion extending axially from an end of the second canister portion including a wall that is inclined outwardly, away from the central axis of the multiple piece canister, the wall of the conical portion and the wall of the funnel portion defining an insulation gap therebetween and an annular band of insulating and cushioning mat material disposed under compression by the walls within the insulation gap.

The above features and advantages, and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of the embodiments, the detailed description referring to the drawings in which:

FIG. 1 is a front view of an exhaust treatment system for an internal combustion engine embodying features of the invention;

FIG. 2 is a cross-section of a portion of the exhaust treatment system of FIG. 1 taken prior to assembly of the multiple piece canister; and

FIG. 3 is a cross-section of a portion of the exhaust treatment system of FIG. 1 taken following assembly of the multiple piece canister.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

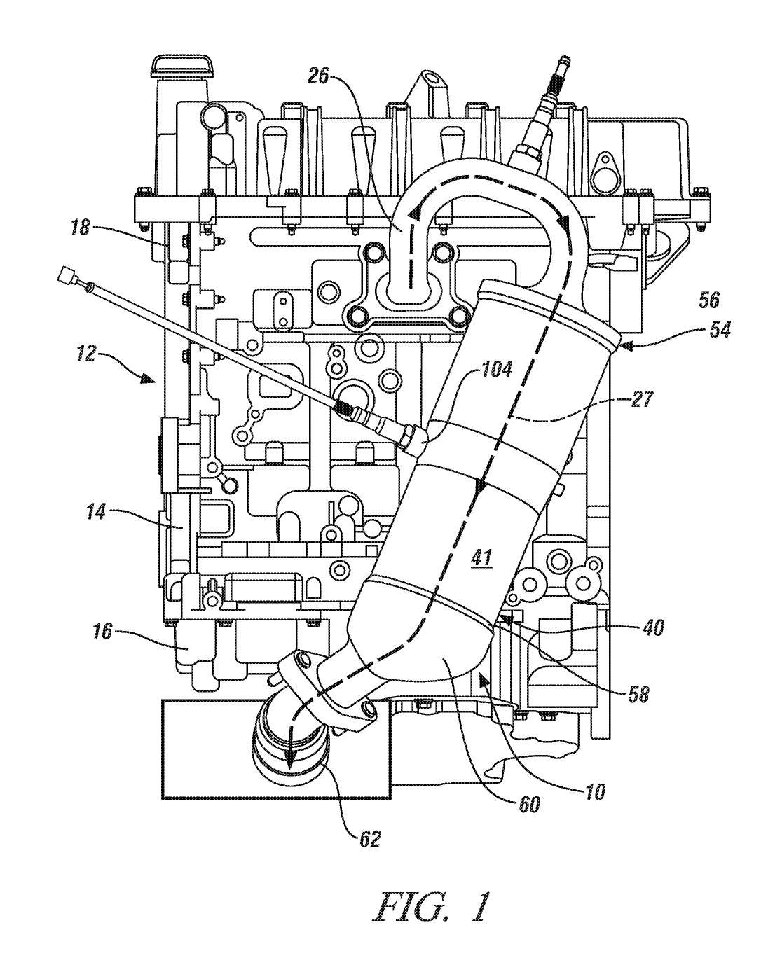

Referring now to FIG. 1, an exemplary embodiment is directed to an exhaust system 10, for the reduction of regulated exhaust gas constituents produced by an internal combustion engine 12. It is appreciated that the internal combustion engine 12 may be one of various configurations and types, such as gas or diesel, in-line or V-configured. For ease of description and discussion, the disclosure will be discussed in the context of the in-line four cylinder gasoline engine shown in the FIG. 1. The internal combustion engine 12 includes a cylinder block 14 that is typically constructed of cast iron or a lighter weight alloy such as aluminum. The lower end of the cylinder block 14 is closed by an oil pan 16 while the upper end is closed by a cylinder head 18.

In an exemplary embodiment, the cylinder head 18 is associated with an exhaust manifold 26 that is configured to conduct combustion constituents or exhaust gas 27 therefrom. Referring to FIGS. 1, 2 and 3, in an exemplary embodiment, an exhaust treatment system 40 includes a multiple piece canister 41 that is configured to support a plurality of catalyst substrates. In the exemplary embodiment illustrated, the exhaust treatment system 40 may be referred to as a Split Volume Common Can (“SVCC”) Catalytic Converter having a first and a second catalyst substrate 44 and 45 disposed in axial alignment therein. The catalyst substrates 44, 45 respectively, may be constructed of a ceramic honeycomb, a metal honeycomb or other suitable structure.

In an exemplary embodiment, exhaust gas passages 46, which are essentially direct paths from the upstream fluid inlets 48 to the downstream fluid outlets 50 of each substrate 44, 45, may be defined by substantially longitudinally extending walls 52 on which various catalytic materials (not shown) are coated so that the exhaust gas 27 that passes through the catalyst substrates 44 and 45 contacts the catalytic material to thereby initiate a chemical conversion process. For example, in an exemplary embodiment, as the exhaust gas 27 traverses the length of the first catalyst substrate 44 a precious metal or Platinum group metal catalyst compound, including platinum group metals such as platinum (Pt), palladium (Pd), rhodium (Rh) or other suitable oxidizing catalysts, or combination thereof, catalyzes the oxidation of carbon monoxide (“CO”) to carbon dioxide (“CO₂”) in the presence of oxygen (“O2”), as well as catalyzing the oxidation of various hydrocarbons, including gaseous HC and liquid HC particles including unburned fuel or oil as well as HC reductants, that may have been introduced into the exhaust gas 27, to form CO₂ and H₂0. As the exhaust gas traverses the length of the second catalyst substrate 45 a precious metal or Platinum group metal catalyst compound, including platinum group metals such as platinum (Pt), palladium (Pd), rhodium (Rh) or other suitable oxidizing catalysts, or combination thereof, catalyzes the oxidation of remaining carbon monoxide (“CO”) to carbon dioxide (“CO₂”) in the presence of oxygen (“O2”), as well as catalyzing the oxidation of various remaining hydrocarbons, including gaseous HC and liquid HC particles including unburned fuel or oil as well as HC reductants, that may have been introduced into the exhaust gas 27, to form CO₂ and H₂0. Other combinations of catalyst compounds, such as a Selective Catalyst Reduction (“SCR”) catalyst, are of course contemplated and will be selected based on various parameters such as the type of engine (ex. diesel or gasoline) as well as the application of the internal combustion engine 12 and/or the vehicle type in which the engine is operated.

Closing a first inlet end 54 of the canister 41 is an inlet end cone 56 that is in fluid communication with the exhaust manifold 26 of the cylinder head 18 and is configured to receive exhaust gas therefrom for passage through the first and second catalyst substrates 44 and 45, respectively. Similarly, closing the second, outlet end 58 of the multiple piece canister 41 is an outlet end cone 60 that may be configured in a cone or semi-conical configuration to provide a smooth transition of the exhaust gas to an exhaust gas conduit 62 with which the collector outlet end cone 60 is in fluid communication.

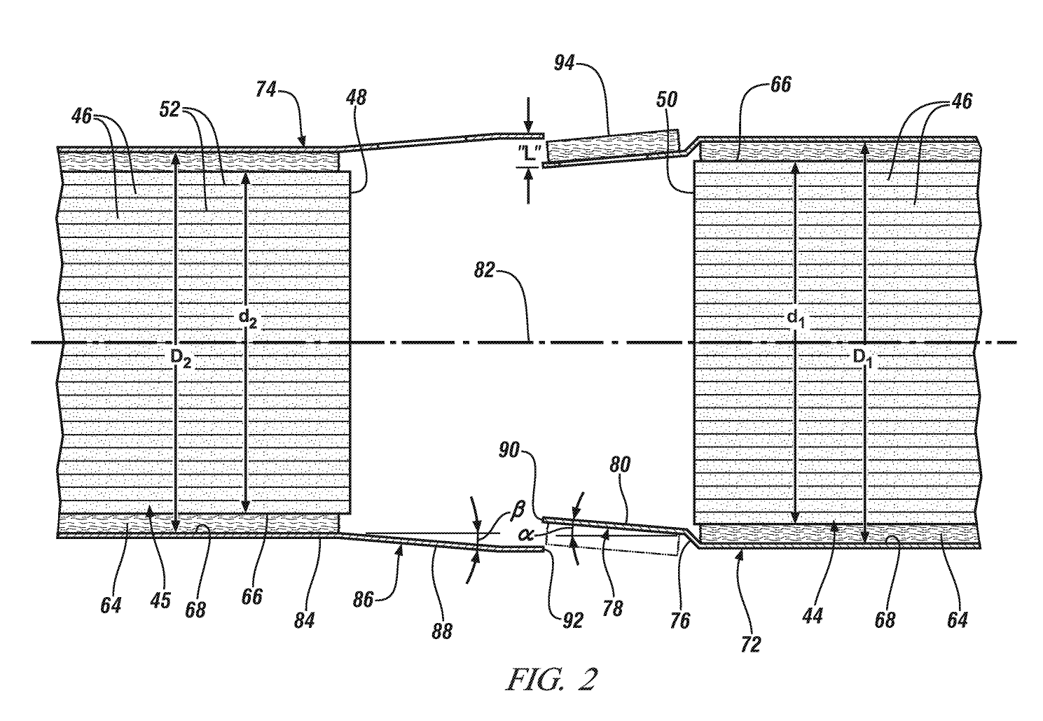

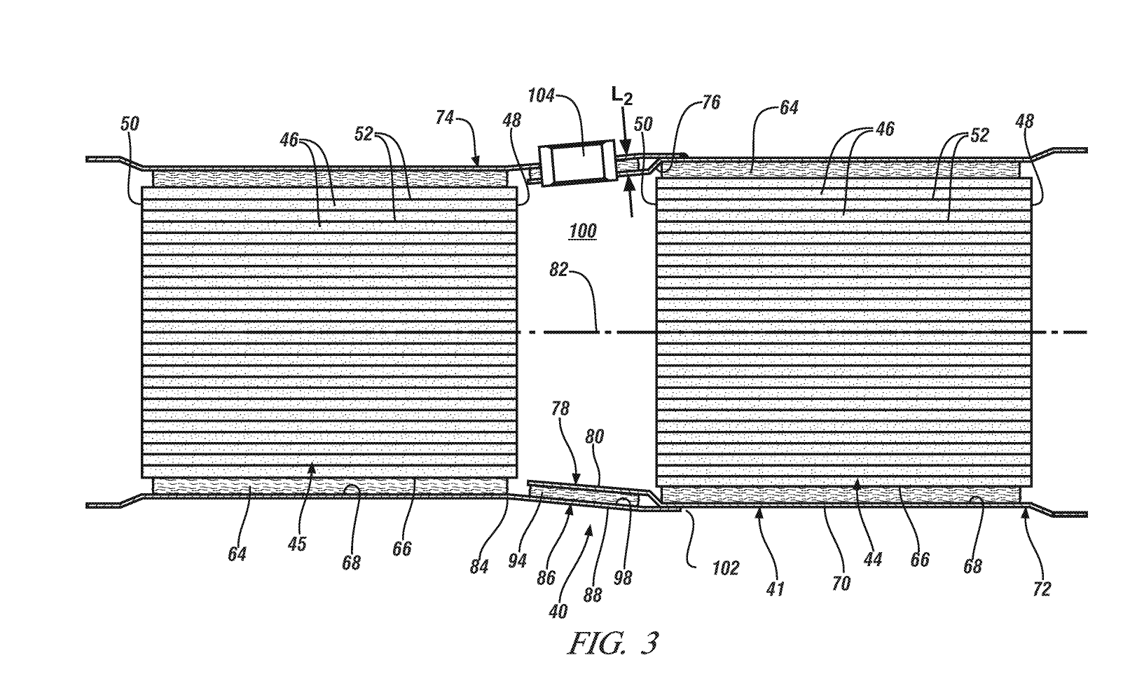

Referring particularly to FIGS. 2 and 3, in an exemplary embodiment an insulating and cushioning mat material 64 is interposed between the outer surface perimeter 66 of the flow-through substrates 44, 45 and the inner wall 68 of the canister 41. The mat material 64 may be of the type commonly referred to as an intumescent mat or, may be a non-intumescent mat. The selection of the mat material 64 is dependent on the internal combustion engine 10 to which the exhaust treatment system 40 is applied as well as other considerations. Regardless of the type of insulating and cushioning mat material 64 selected, the mat material operates to support the catalyst substrates 44, 45 in the multiple piece canister 41 against damage from external shock and movement therein. In addition, the mat material 64 defines a thermal barrier between the catalyst substrates 44, 45 and the inner wall 68 of the multiple piece canister 41 to reduce the temperature of the outer wall 70 thereof.

Referring particularly to FIGS. 2 and 3, the multiple piece canister 41 comprises a first canister portion 72 and a second canister portion 74. Each canister portion 72, 74 is configured to support one of the catalyst substrates 44, 45, respectively. The first canister portion 72 has a diameter D₁ while the second canister portion 74 has a diameter D₂ where D₁>D₂. Similarly the first catalyst substrate 44 has a diameter d₁ while the second catalyst substrate 45 has a diameter d₂ where d₁>d₂. Extending axially from end 76 of first canister portion 72 is a conical portion 78. The conical portion 78 includes a wall 80 that is inclined inwardly, towards the central axis 82 of the multiple piece canister 41 at an angle “a” that may range from about 5° to about 45°. The angle “a” will be selected based on several factors such as the axial length of the wall 80 of the conical portion 78 as well as the extent to which D₁>D₂. Extending axially from end 84 of second canister portion 74 is a funnel portion 86. The funnel portion 86 includes a wall 88 that is inclined outwardly, away from the central axis 82 of the multiple piece canister 41 at an angle “β” that may range from about 5° to about 45°. The angle “β” will be selected based on several factors such as the axial length of the wall 88 of the funnel portion 86, the extent to which D₁>D₂ and, more particularly, the angle “α”. In an exemplary embodiment angle “α” equals “β”.

Referring to FIG. 2, prior to assembly of the multiple piece canister 41 of the SVCC catalytic converter, the end 90 of the conical portion 78 of the first canister portion 72 and the end 92 of the funnel portion 86 of the second canister portion 74 define a radial separation “L” when the first and second canister portions are brought into axial alignment and an annular band of insulating and cushioning mat material 94, may be disposed about the wall 80 of the conical portion 78. Subsequently, the first and second canister portions 72, 74 are moved axially together along central axis 82 until the end 92 of the funnel portion 86 is positioned circumferentially about and adjacent to the outer wall 70 of the first canister portion 72, FIG. 3. As the first and second canister portions are moved axially together along central axis 82, as illustrated in FIG. 3, an insulation gap 98 is defined between the wall 80 of the conical portion 78 and the wall 88 of the funnel portion 86. The gap 98 extends circumferentially about the axially extending gap 100 defined between the first and second catalyst substrates 44 and 45, respectively and houses the annular band of insulating and cushioning mat material 94 therein. As the first and second canister portions 72, 74, respectively are moved axially together along central axis 82 the radial separation “L” between the wall 80 of the conical portion 78 and the wall 88 of the funnel portion 86 is reduced to a radial separation of “L₂” where “L”>“L₂”. The radial reduction of the axially extending gap during assembly of the multiple piece canister acts to place the annular band of insulating and cushioning mat material 94 in compression, thereby fixing the material in place within the insulation gap 98 and avoiding sliding forces on the mat material 94 that may cause dimensional damage to the mat and resulting failure to effectively insulate the axially extending gap 100. The first and second canister portions 72, 74 are subsequently fixed together by welding at 102 or by other suitable manner of connection. In an exemplary embodiment, a sensor mount 104, FIGS. 1 and 3, may be disposed in the axially extending gap 100. The sensor mount 104 is configured to receive one of a number of sensors such as a temperature sensor, a NOₓ sensor, and Oxygen sensor, or a combination thereof.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the present application.

What is claimed is:

1. An exhaust gas treatment system for an internal combustion engine comprising:
a multiple piece canister comprising a first canister portion and a second canister portion;
a conical portion extending axially from an end of the first canister portion including a wall that is inclined inwardly, towards a central axis of the multiple piece canister;
a funnel portion extending axially from an end of the second canister portion including a wall that is inclined outwardly, away from the central axis of the multiple piece canister, the wall of the conical portion and the wall of the funnel portion defining an insulation gap therebetween; and
an annular band of insulating and cushioning mat material disposed, under compression by the walls, within the insulation gap.

2. The exhaust gas treatment system of claim 1, further comprising:
a first catalyst substrate disposed in the first canister portion;
a second catalyst substrate disposed in the second canister portion;
an insulating and cushioning mat material interposed between an outer surface of the first catalyst substrate and an inner wall of the first canister portion;
an insulating and cushioning mat material interposed between an outer surface of the second catalyst substrate and an inner wall of the second canister portion; and
an axially extending gap defined between the first and second catalyst substrates.

3. The exhaust gas treatment system of claim 1, wherein the wall of the conical portion is inclined inwardly, towards the central axis of the multiple piece canister at an angle “a” that may range from about 5° to about 45°.

4. The exhaust gas treatment system of claim 3, wherein the wall of the funnel portion is inclined outwardly, away from the central axis of the multiple piece canister at an angle “β” that may range from about 5° to about 45°.

5. The exhaust gas treatment system of claim 4, wherein the angle “α” equals the angle “β”.

6. The exhaust gas treatment system of claim 1, wherein the first canister portion has a diameter D₁ and the second canister portion has a diameter D₂.

7. The exhaust gas treatment system of claim 6, wherein the diameter D₁ is greater than the diameter D₂.

8. The exhaust gas treatment system of claim 2, wherein the first catalyst substrate has a diameter d₁ and the second catalyst substrate has a diameter d₂.

9. The exhaust gas treatment system of claim 8, wherein the diameter d₁ is greater than the diameter d₂.

10. A method for assembling an exhaust gas treatment system for an internal combustion engine comprising a multiple piece canister comprising a first canister portion and a second canister portion, a conical portion extending axially from an end of the first canister portion including a wall that is inclined inwardly, towards a central axis of the multiple piece canister, a funnel portion extending axially from an end of the second canister portion including a wall that is inclined outwardly, away from the central axis of the multiple piece canister, the wall of the conical portion and the wall of the funnel portion defining an insulation gap therebetween and an annular band of insulating and cushioning mat material disposed under compression by the walls within the insulation gap comprising:
disposing the annular band of insulating and cushioning mat material about the wall of the conical portion; and
moving the first and second canister portions axially together along the central axis until an end of the wall of the funnel portion is positioned circumferentially about, and adjacent to, an outer surface of the first canister portion to define an insulation gap between the wall of the conical portion and the wall of the funnel portion, wherein the annular band of insulating and cushioning mat material is in compression between the walls to thereby fix the material in place within the insulation gap.

11. The method for assembling an exhaust gas treatment system of claim 10, further comprising fixing the first and second canister portions together by welding.

12. An internal combustion engine having an exhaust gas treatment system comprising:
an exhaust manifold configured to conduct exhaust gas from the engine;
a split volume, common can catalytic converter configured to receive the exhaust gas and comprising:
a multiple piece canister comprising a first canister portion and a second canister portion;
a conical portion extending axially from an end of the first canister portion including a wall that is inclined inwardly, towards a central axis of the multiple piece canister;
a funnel portion extending axially from an end of the second canister portion including a wall that is inclined outwardly, away from the central axis of the multiple piece canister, the wall of the conical portion and the wall of the funnel portion defining an insulation gap therebetween; and
an annular band of insulating and cushioning mat material disposed under compression by the walls within the insulation gap.

13. The internal combustion engine of claim 12, further comprising:
a first catalyst substrate disposed in the first canister portion;
a second catalyst substrate disposed in the second canister portion;
an insulating and cushioning mat material interposed between an outer surface perimeter of the first catalyst substrate and an inner wall of the first canister portion;
an insulating and cushioning mat material interposed between an outer surface perimeter the second catalyst substrate and an inner wall of the second canister portion; and
an axially extending gap defined between the first and second catalyst substrates.

14. The internal combustion engine of claim 12, wherein the wall of the conical portion is inclined inwardly, towards the central axis of the multiple piece canister at an angle “a” that may range from about 5° to about 45°.

15. The internal combustion engine of claim 14, wherein the wall of the funnel portion is inclined outwardly, away from the central axis of the multiple piece canister at an angle “β” that may range from about 5° to about 45°.

16. The internal combustion engine of claim 15, wherein the angle “α” equals the angle “β”.

17. The internal combustion engine of claim 12, wherein the first canister portion has a diameter D₁ and the second canister portion has a diameter D₂.

18. The internal combustion engine of claim 17, wherein the diameter D₁ is greater than the diameter D₂.

19. The internal combustion engine of claim 13, wherein the first catalyst substrate has a diameter d₁ and the second catalyst substrate has a diameter d₂.

20. The internal combustion engine of claim 19, wherein the diameter d₁ is greater than the diameter d₂.
